(19) United States
(12) Patent Application Publication
(10) Pub. No.: US 2016/0253173 A1
(43) Pub. Date: Sep. 1, 2016

(54) Word processing plus/basic

(71) Applicant: Michael Lewis Moravitz, Fairfax, VA (US)

(72) Inventor: Michael Lewis Moravitz, Fairfax, VA (US)

(21) Appl. No.: 14/999,168

(22) Filed: Apr. 7, 2016

(51) Int. Cl. G06F 9/44; G06F 17/24

(52) U.S. Cl. CPC G06F 8/71; G06F 17/24

(57) ABSTRACT

Major word processing software should have a Plus version with the full range of function, but also a Basic version for most users, who do not need all the possibilities in the most sophisticated programs.

Word processing software, such as MS Word in Office 365, is too complicated for many users.

However, it has many functions that may be useful to high-end users, including academics. Microsoft, Apple Corporation, and other software providers should allow their customers a choice between a Plus word processing system and a Basic word processing system, which would not have all the complicated functions associated with modern programs. Instead, it would have limited functions for most users—perhaps even built on earlier versions of Word or Word Perfect. This stripped down version would have all the functions necessarily to produce letters, most school papers, many office memos and other documents. This would simplify word processing for many users and would be a key selling point for the software manufacturer who accepts the idea. You might provider the ability to turn a document in Basic into Plus if a user finds that he or she needs the additional functionality. Even cheaper computers might only provide the Basic version of word processing (and other software)—to make PCs and Macs more affordable for some users. A Basic software package computer might be acceptable to more customers—and profitable for the companies that manufacture them.

1) Builds on patents for MS Word;

2) Word Perfect; and

3) Other word processing programs.
